(19) United States
(12) Patent Application Publication
(10) Pub. No.: US 2010/0064647 A1
(43) Pub. Date: Mar. 18, 2010

(54) POLYMER OR OLIGOMER FIBERS BY SOLVENT-FREE ELECTROSPINNING

(76) Inventors: Gerrit J. Brands, Terneuzen (NL); Rene Broos, Bornem (BE); Rudolf J. Koopmans, Kruibeke (BE); Joey W. Storer, Midland, MI (US); Leonardo C. Lopez, Midland, MI (US); James F. Sturnfield, Rosharon, TX (US)

Correspondence Address: The Dow Chemical Company, Intellectual Property Section, P.O. Box 1967, Midland, MI, 48641-1967, US

(21) Appl. No.: 12/526,814

(22) PCT Filed: Feb. 14, 2008
(86) PCT No.: PCT/US08/53917

§ 371 Date: Aug. 12, 2009

Related U.S. Application Data
(60) Provisional application No. 60/901,630, filed on Feb. 14, 2007.

(51) Int. Cl. B29C 47/00; D02G 3/02; B01D 39/16

(52) U.S. Cl. 55/528; 264/465; 428/401; 442/401

(57) ABSTRACT

A process for fabricating fibers, including nano-scale fibers, comprising electrospinning a melt of a self assembling material and fibers fabricated by the process are disclosed.

### FIELD OF THE INVENTION

The invention relates to processes for fabricating fibers, preferably submicron fibers, by melt electrospinning, and to the fibers prepared thereby.

### BACKGROUND OF THE INVENTION

Micron and submicron fibers can be formed by electrospinning processes. In electrospinning, a droplet of polymer solution or melt is elongated by a strong electrical field. The resulting fibers are collected as non-woven mats or as individual spun fibers. The fibers generally have large surface to volume ratio and consequently are useful for various applications including filtration.

Most electrospinning processes are solution based, i.e., the fibers are generated from a solution of the polymer. There are several disadvantages to solution electrospinning, including the required step of dissolving the polymer in a solvent, the cost of solvent recovery and recycling or disposal, and the lower yield of fibers.

Melt electrospinning overcomes some of the disadvantages of solvent electrospinning, but prior art systems still exhibit several shortcomings, including the tendency of forming thicker fibers (micron range) which is attributed to the high melt viscosities of the polymer used. Further, in most previous applications related to melt electrospinning fibers, the production rates are lower.

Thus, a clear need exists for new melt electrospinning technologies that overcome the shortcomings of the prior art. Particularly needed are polymers that melt at useful temperatures, and that exhibit properties in the melt state that are amenable to high productivity melt electrospinning.

### BRIEF SUMMARY OF THE INVENTION

In one aspect, the invention provides a process for fabricating fibers, preferably submicron fibers. In another aspect, the process comprises electrospinning a melt of a self assembling material. The term “self-assembling material” means an oligomer or polymer that effectively forms larger associated or assembled oligomers and/or polymers through the physical intermolecular associations of chemical functional groups. Without wishing to be bound by theory, it is believed that the intermolecular associations do not increase the molecular weight (Mn) or chain length of the self-assembling material and covalent bonds between said materials do not form. This combining or assembling occurs spontaneously upon a triggering event such as cooling to form the larger associated or assembled oligomer or polymer structures. Examples of other triggering events are the shear-induced crystallizing of, and contacting a nucleating agent to, a melt electrospun self assembling material. In another aspect, the invention provides fibers, preferably submicron fibers, prepared by the melt electrospinning process described herein.

In a further aspect, the invention provides fibers prepared from the self-assembling materials described herein, wherein the fibers can be (i.e., may be) in the range in diameter between about 30 nanometers (nm) and about 1000 nm or the fibers may be in the range in diameter between about 50 nm and about 1000 nm.

### BRIEF DESCRIPTION OF THE DRAWINGS

FIGS. 1A and 1B are SEM images of fibers prepared according to one embodiment of the process of the invention.

### DETAILED DESCRIPTION OF THE INVENTION

In one aspect, the invention provides a process for forming fibers (e.g., non-woven) by melt electrospinning of self-assembling materials. The self-assembling materials useful for melt electrospinning are characterized in that they exhibit relative low viscosity in the melt phase typical of low molecular weight polymers or oligomers and exhibit some of the mechanical properties of higher molecular weight polymers in the solid phase. These self assembling materials can have number average molecular weights (Mn) between about 1000 grams per mole (g/mol) and about 30,000 g/mol, preferably between about 2000 g/mol and about 20,000 g/mol and in other embodiments, can have Mn of between 5000 g/mol and 18,000 g/mol. For clarity, reference to “molecular weight” means number average molecular weight (Mn) unless otherwise expressly disclosed. Preferably, polydispersities of substantially linear self-assembling materials is 4 or less, more preferably 3 or less, still more preferably 2.5 or less, still more preferably 2.2 or less. Self assembling fiber-forming materials according to the present invention exhibit relatively low viscosity in the melt (that is, from the melting point upward in temperature) and consequently are well suited for processing by rapid melt electrospinning solvents are not needed. Because the materials useful in the present invention self associate to form associated or “interconnected” structures upon solidification, crystallization, and the like, their final properties are advantageously typical of higher molecular weight polymers. Upon melt electrospinning, the materials produce thin fibers, without beading (which is indicative of a disruption of uniform fiber formation) at considerably higher output rates than otherwise customary in the industry. In addition, the steps of solvent recovery, recycling or disposal, typical of solution spinning, are not required in the process of the invention, thereby making the process less costly in terms of both cost for solvent and energy requirements per unit of fiber produced. Accordingly, the melt-base process of the invention is significantly more environmentally friendly than solution based systems. Also the process permits, at elevated temperatures above the self assembling material's melting point, production of aseptic fibers (i.e., fibers that are essentially free of microorganisms).

The fibers of the invention are generally suitable for use in a variety of applications such as, without being exclusive, filtration, cleaning, acoustical, medical, and energy conservation applications, and can be used, for instance, for manufacturing medical gowns, cosmetics, sound insulation, medical scaffolds, apparel, and barrier materials. More specifically, the fibers are suitable for use in short-life and long-life applications such as those defined by INDA end-use classification (Association of Non-woven Fabrics Industry, Cary, N.C.) including, but not limited to, hygiene (diaper coverstock, adult incontinence, training pants, underpads, feminine hygiene), wiping cloths, medical/surgical, filtration (air, gasses, liquids), durable paper, industrial garments, fabric softeners, home furnishings, geotextiles, building and construction, floor covering backings, automotive fabrics, coatings and laminating substrates, agricultural fabrics, apparel interfacings and linings, shoes and leather, and electronic components.

### Self-Assembling Materials

The self-assembling materials for use in the invention are oligomers or polymers that effectively form larger oligomers or polymers, upon a triggering event, through the physical intermolecular association of functional groups in the material. The materials contain functional groups capable of strong directional interactions, such as (a) electrostatic interactions (ion-ion, ion-dipole or dipole-dipole) or coordinative bonding (metal-ligand), (b) hydrogen bonding, (c) π-π stacking interactions, and/or (d) van der Waals forces. The preferred materials assemble upon cooling from the melt state and form supramolecular structures whose mechanical properties mimic to a useful degree, at end use temperatures, the advantageous physical properties of higher molecular weight or even cross-linked polymers.

Association of multiple-hydrogen-bonding arrays is the preferred mode of self assembly. A description of self assembling multiple H-bonding arrays can be found in “Supramolecular Polymers” Alberto Ciferri Ed., 2nd Edition, pages (pp) 157-158. The extent of self assembly or the strength of interaction is measured by the association constant K(assoc). K(assoc) may range from 10² to 10⁹ reciprocal molarity (M⁻¹) (ibid. p 159, FIG. 5).

Thus, in preferred aspects, the self-assembling material for use in the invention comprises self assembling units that themselves comprise multiple hydrogen bonding arrays. Preferably, the multiple hydrogen bonding arrays have an association constant K(assoc) of greater than 10³ M⁻¹. Also preferably, the multiple H-bonding arrays comprise an average of 2 to 8, preferably 4-6, more preferably greater than 4, donor-acceptor hydrogen bonding sites per self assembling unit. Preferred self assembling units in the self assembling material are bis-amides, bis-urethanes and bis-urea units or their higher oligomers. In other preferred embodiments, the self assembling material comprises a polyester-amide, polyether-amide, polyester-urethane, polyether-urethane, polyether-urea, polyester-urea, or a mixture thereof.

The viscosity of the self-assembling material is preferably less than 100 Pa.sec. at from above Tm up to about 40° C. above Tm. The viscosity of one of the preferred self assembling materials of the invention is preferably less than 100 Pa.sec. at 190 degrees Celsius, and more preferably in the range of from 1 to 50 Pa.sec. at 160 degrees Celsius. Preferably, the glass transition temperature of the materials is less than 20 degrees Celsius. Preferably, the melting point is higher than 60 degrees Celsius. Embodiments according to the present invention can exhibit multiple T_{g}, glass transition temperatures. In a preferred embodiment, the self assembling material has a glass transition temperature T_{g} that is higher than −80° C., and in another preferred embodiment, a glass transition temperature is higher than 60° C.

As used herein, the term viscosity means zero shear viscosity unless specified otherwise. The term “Tm” means melting point as determined by techniques known in the art such as differential scanning calorimetry.

The Tensile modulus of one preferred group of self assembling materials useful in the invention is preferably from 15 megapascals (MPa) to 500 MPa at room temperature, preferably 20 degrees Celsius (° C.). Tensile modulus testing is well known in the polymer arts.

Preferably, the storage modulus of self assembling materials useful in the invention is at least 50 MPa, more preferably at least 100 MPa, or still more preferably at least about 150 MPa, all at 20° C. Preferably, the storage modulus is 400 MPa or lower, more preferably 300 MPa or lower, still more preferably 250 MPa or lower, or still more preferably about 200 MPa or lower, all at 20° C.

Preferred classes of self-assembling materials suitable for use in the invention are polyester-amide, polyether-amide, polyester-urethane, polyether-urethane, polyether-urea, polyester-urea, and mixtures thereof, such as those described in U.S. Pat. No. 6,172,167 and applicant's co-pending PCT application numbers PCT/US2006/023450 and PCT/US2006/035201, each of which is incorporated herein by reference.

In one embodiment (embodiment I-1), the polymer or oligomer comprises a first repeat unit represented by the formula -[H1-AA]- and a second repeat unit represented by the formula -[DV-AA]-, where H1 is —R—CO—NH—Ra—NH—CO—R—O— or —R—NH—CO—R—CO—NH—R—O— where Ra is R or a bond, R is independently in each occurrence an aliphatic or heteroaliphatic, alicyclic or heteroalicyclic or aromatic or heteroaromatic group, preferably R is an aliphatic group of 1 to 10, preferably 1-6 carbon atoms and AA is a —CO—R′—CO—O— where R′ is a bond or an aliphatic group, preferably of 1 to 10, more preferably 2-6 carbon atoms, where DV is -[R″—O]- and R″ is an aliphatic or heteroaliphatic, alicyclic or heteroalicyclic or aromatic or heteroaromatic group. Preferably, R″ is selected such that R″(OH)₂ can be distilled off from the reaction mixture in subsequent derivation of the polymer or oligomer. Preferably, R″ is an aliphatic group of 1 to 8, more preferably 2 to 6, carbon atoms. The number average molecular weight of the polymer or oligomer is preferably between 1000 g/mol and 30,000 g/mol, preferably between 2,000 g/mol and 20,000 g/mol, more preferably 5,000 g/mol to 12,000 g/mol. Thus, in some aspects, the molecular weight is preferably at least about 1000 g/mol, more preferably at least about 2000 g/mol, still more preferably at least about 3000 g/mol, and even more preferably at least about 5000 g/mol. In further aspects, the molecular weight is preferably about 30,000 g/mol or less, more preferably about 20,000 g/mol or less, still more preferably, about 15,000 g/mol or less, and even more preferably about 12,000 g/mol or less.

According to one representation, the polymer or oligomer of embodiment I-1 may be represented as having the formula HO-D1-O—[—CO-AA1-CO—O-D1-O-]x-[CO-AA1-CO—O-AD-O]_{y}—H, wherein O-D1-O represents the residual of a volatile diol functionality, wherein CO-AA1-CO represents the residual of an aliphatic dicarboxylic acid functionality (preferably short e.g. 6 or fewer carbon atoms), and O-AD-O represents a residual of a preferably short (e.g. preferably 6 or fewer carbon atoms in the diamine) symmetrical, crystallizing amid diol functionality, wherein x and y are the number of each repeat units preferably selected such that the number average molecular weight of the polymer or oligomer is between 1000 g/mol and 30,000 g/mol, more preferably between 2,000 g/mol and 20,000 g/mol, still more preferably 5,000 g/mol to 12,000 g/mol. Thus, in some aspects, the molecular weight is preferably at least about 1000 g/mol, more preferably at least about 2000 g/mol, still more preferably at least about 3000 g/mol, and even more preferably at least about 5000 g/mol. In further aspects, the molecular weight is preferably about 30,000 g/mol or less, more preferably about 20,000 g/mol or less, still more preferably, about 15,000 g/mol or less, and even more preferably about 12,000 g/mol or less.

In a second embodiment (embodiment I-2), the polymer or oligomer comprises repeat units -[H1-AA]-, -[DV-AA]-, and -[D2-O-AA]-, where D2 is independently in each occurrence an aliphatic or heteroaliphatic, alicyclic or heteroalicyclic or aromatic or heteroaromatic group, and preferably D2 is an aliphatic group.

According to one representation, the polymer or oligomer of embodiment I-2 may be represented as having the formula HO-D2-O—[—CO-AA1-CO—O-D1,2-O-]x-[CO-AA1-CO—O-AD-O]y-H, wherein O-D2-O represents a residual non-volatile diol functionality, wherein CO-AA1-CO represents the residual of the aliphatic dicarboxylic acid functionality, wherein O-AD-O represents the residual of the polyamide diol functionality, wherein O-D1,2-O represents the residual of the volatile diol functionality or the nonvolatile diol functionality, wherein x and y are the number of each of the repeat units in the polymer or oligomer. Nonvolatile diols are defined in this specification as having a molecular weight greater than 1,7 heptane diol. The number average molecular weight of the transformed polymer or oligomer preferably being greater than 1000 g/mol, preferably greater than 4,000 g/mol.

In a third embodiment (embodiment I-3), the polymer or oligomer comprises repeat units -[H1-AA]-, -[R—O-AA]-, and M-(AA)ₙ-, wherein M is an n valent organic moiety, preferably aliphatic or heteroaliphatic, alicyclic or heteroalicyclic or aromatic or heteroaromatic group, preferably having up to 20 carbon atoms, and n is 3 or more.

According to one representation (with a single polyfunctional moiety M built in the chain, though a plurality of M is possible) the polymer or oligomer of embodiment I-3 may have the formula HO-D1-O—[—CO-AA1-CO—O-D1-O-]x-[CO-AA1-CO—O-AD-O]y—CO-AA1-CO—O-M-(O—[CO-AA1-CO—O-D1]_{X}—O—[CO-AA1-CO—O-AD-O]_{y}—H)ₙ₋₁, wherein O-D1-O represents the residual of the diol functionality, wherein CO-AA1-CO represents the residual of the aliphatic dicarboxylic acid functionality, wherein O-AD-O represents the residual of the polyamide diol functionality, wherein x and y are the number of each of the repeat units in the polymer or oligomer, the number average molecular weight of the polymer or oligomer preferably being greater than 1000 g/mol, preferably greater than 4,000 g/mol. In some aspects, the molecular weight is preferably at least about 1000 g/mol, more preferably at least about 2000 g/mol, still more preferably at least about 3000 g/mol, and even more preferably at least about 5000 g/mol. In further aspects, the molecular weight is preferably about 30,000 g/mol or less, more preferably about 20,000 g/mol or less, still more preferably, about 15,000 g/mol or less, and even more preferably about 12,000 g/mol or less.

In another embodiment (embodiment I-4), the polymer or oligomer comprises repeat units -[H1-AA]-, -[R—O-AA]-, and -PA-(CO—O—R)—, wherein PA is an n valent organic moiety, preferably aliphatic or heteroaliphatic, alicyclic or heteroalicyclic or aromatic or heteroaromatic group, preferably having up to 20 carbon atoms, and n is 3 or more.

According to one representation (with a single polyfunctional moiety PA built in the chain, though a plurality of PA is possible) the polymer or oligomer of embodiment I-4 may have the formula HO-D1-O—[—CO-AA1-CO—O-D1-O-]x-[CO-AA1-CO—O-AD-O]y—CO-PA-(CO—O-D1-[O—OC-AA1-CO—O-D1-O]ₓ—[CO-AA1-CO—O-AD-O]y-H)ₙ₋₁, wherein O-D1-O represents the residual of the diol functionality, wherein CO-AA1-CO represents the residual of the aliphatic dicarboxylic acid functionality, wherein O-AD-O represents the residual of the polyamide diol functionality, wherein x and y are the number of each of the repeat units in the polymer or oligomer, the number average molecular weight of the polymer or oligomer preferably being greater than 1000 g/mol, preferably greater than 4,000 g/mol. In some aspects, the molecular weight is preferably at least about 1000 g/mol, more preferably at least about 2000 g/mol, still more preferably at least about 3000 g/mol, and even more preferably at least about 5000 g/mol. In further aspects, the molecular is preferably about 30,000 g/mol or less, more preferably about 20,000 g/mol or less, still more preferably, about 15,000 g/mol or less, and even more preferably about 12,000 g/mol or less.

In another embodiment (embodiment I-5), the polymer or oligomer comprises repeat units -[H2-D]-, -[R—O-AA]-, and -M-(AA)ₙ-, where H2 is —CO—R—CO—NH—R—NH—CO—R—CO—O— where R is independently in each occurrence an aliphatic or heteroaliphatic, alicyclic or heteroalicyclic or aromatic or heteroaromatic group, preferably R is an aliphatic group of 1 to 10, preferably 2-4 carbon atoms and where D is -[R—O]- and R is a an aliphatic or heteroaliphatic, alicyclic or heteroalicyclic or aromatic or heteroaromatic group.

According to one representation, the polymer or oligomer of embodiment I-5 may be represented by the formula (with a single polyfunctional moiety M built in the chain, though a plurality of M is possible): HO-D1-O—[—CO-AA1-CO—O-D1-O-]x-[O-D1-O—CO-DD-CO-]_{y}—O-M-(O—[CO-AA1-CO—O-D1]x-O—[O-D1-O—CO-DD-CO]y-OH)ₙ₋₁, wherein O-D1-O represents the residual of the diol functionality, wherein CO-AA1-CO represents residual of the aliphatic dicarboxylic acid functionality, wherein O—CO-DD-CO—O represents residual of the diamide diacid functionality, wherein x and y are the number of each repeat units in the polymer or oligomer. Preferably, the polymer or oligomer has a number average molecular weight greater than 1000 g/mol, preferably greater than 4000 g/mol. In some aspects, the molecular weight is preferably at least about 1000 g/mol, more preferably at least about 2000 g/mol, still more preferably at least about 3000 g/mol, and even more preferably at least about 5000 g/mol. In further aspects, the molecular weight is preferably about 30,000 g/mol or less, more preferably about 20,000 g/mol or less, still more preferably, about 15,000 g/mol or less, and even more preferably about 12,000 g/mol or less.

In another embodiment (embodiment I-6), the polymer or oligomer comprises repeat units -[H2-AA]-, -[R—O-AA]-, and -PA-(COOR)n-.

According to one representation of embodiment I-6 (with a single polyfunctional moiety PA built in the chain, though a plurality of PA is possible) the polymer or oligomer may be represented by the formula HO-D1-O—[—CO-AA1-CO—O-D1-O-]x-[OC-DD-CO—O-D1-O]_{y}OC-PA-([—CO—O-D1-O—CO-AA1-CO-]ₓ[O-D1-O—CO-DD-CO]y-OH)ₙ₋₁, wherein O-D1-O represents the residual of the diol functionality, wherein CO-AA1-CO represents residual of the aliphatic dicarboxylic acid functionality, wherein O—CO-DD-CO—O represents residual of the diamide diacid functionality, wherein x and y are the number of each of the repeat units in the polymer or oligomer. Preferably, the polymer or oligomer has a number average molecular weight greater than 1000 g/mol, preferably greater than 4000 g/mol. In some aspects, the molecular weight is preferably at least about 1000 g/mol, more preferably at least about 2000 g/mol, still more preferably at least about 3000 g/mol, and even more preferably at least about 5000 g/mol. In further aspects, the molecular weight is preferably about 30,000 g/mol or less, more preferably about 20,000 g/mol or less, still more preferably, about 15,000 g/mol or less, and even more preferably about 12,000 g/mol or less.

In another embodiment (embodiment I-7), the polymer or oligomer has the formula HO-D1-O—[—CO-AA1,2-CO—O-D1-O-]x-[CO-AA1,2-CO—O-AD-O]y-H, wherein O-D1-O represents the residual of the diol functionality, wherein CO-AA1,2-CO represents the residual of the aliphatic dicarboxylic acid functionality or the high boiling point diacid ester functionality, wherein O-AD-O represents the residual of the polyamide diol functionality, wherein x and y are the number of repeat units in the polymer or oligomer block inside the brackets. The number average molecular weight of the polymer or oligomer is preferably greater than 1000 g/mol, preferably greater than 4,000 g/mol. In some aspects, the molecular weight is preferably at least about 1000 g/mol, more preferably at least about 2000 g/mol, still more preferably at least about 3000 g/mol, and even more preferably at least about 5000 g/mol. In further aspects, the molecular is preferably about 30,000 g/mol or less, more preferably about 20,000 g/mol or less, still more preferably, about 15,000 g/mol or less, and even more preferably about 12,000 g/mol or less.

In another embodiment (embodiment I-8), the polymer or oligomer comprises repeat units -[H2-D]-, -[H2-O-D2]-, [D-AA]- (preferably, -[DV-AA]-), and -[D2-O-AA]-.

According to one representation the transformed polymer or oligomer of embodiment I-8 may be represented by the formula HO-D2-O—[—CO-AA1-CO—O-D1,2-O-]x-[O-D1,2-O—CO-DD-CO]y-OH, wherein O-D2-O represents the residual of the nonvolatile diol functionality, wherein CO-AA1-CO represents the residual of the aliphatic dicarboxylic acid functionality, wherein O—CO-DD-CO—O represents the residual of the diamide diacid functionality, wherein O-D1,2-O represents the residual of the volatile diol functionality or the nonvolatile diol functionality, wherein x and y are the number of each of the repeat units in the polymer or oligomer, the number average molecular weight of the polymer or oligomer is preferably greater than 1000 g/mol, preferably greater than 4,000 g/mol. In some aspects, the molecular weight is preferably at least about 1000 g/mol, more preferably at least about 2000 g/mol, still more preferably at least about 3000 g/mol, and even more preferably at least about 5000 g/mol. In further aspects, the molecular is preferably about 30,000 g/mol or less, more preferably about 20,000 g/mol or less, still more preferably, about 15,000 g/mol or less, and even more preferably about 12,000 g/mol or less.

In yet another embodiment (embodiment I-9), the polymer or oligomer is of the formula HO-D1-O—[—CO-AA1,2-CO—O-D1-O-]x-[CO-AA1,2-CO—O—CO-DD-CO]y-OH, wherein O-D1-O represents the residual of the diol functionality, wherein CO-AA1,2-CO represents residual of the aliphatic dicarboxylic acid functionality or the high boiling point diacid ester functionality, wherein O—CO-DD-CO—O represents residual of the diamide diacid functionality, wherein x and y are the number of repeat units in the polymer or oligomer block inside the brackets. The number average molecular weight of the polymer or oligomer is preferably greater than 1000 g/mol, preferably greater than 4,000 g/mol. In some aspects, the molecular weight is preferably at least about 1000 g/mol, more preferably at least about 2000 g/mol, still more preferably at least about 3000 g/mol, and even more preferably at least about 5000 g/mol. In further aspects, the molecular weight is preferably about 30,000 g/mol or less, more preferably about 20,000 g/mol or less, still more preferably, about 15,000 g/mol or less, and even more preferably about 12,000 g/mol or less.

For the self-assembling materials described above, it should be noted that, while for convenience the repeat units are as shown, the polymers or oligomers are not necessarily strict block copolymers. The self-assembling materials described above may have a statistical distribution of repeat units. Rather the polymers or oligomers will preferably have segments with an average of 2 repeat units of the same type per segment. Order of addition and time of addition of monomers will impact blockiness of the structure. Further, in the formulas shown the oxygen in the repeat unit or portion of repeat units is drawn as occurring on one end of the repeat unit or portion of the repeat unit. However, the oxygen could have been shown on the other end of the repeat unit or portion of the repeat unit and still represented the same actual structure. The structures represent both variants. It is further noted that neither x nor y is zero.

In a preferred embodiment (embodiment II), the polymer or oligomer is a poly(ester-amide) comprising the formula:

—[C(O)R′C(O)O—R″O]ₓ—[C(O)R′C(O)O—RC(O)N(H)RaN(H)C(O)RO]_{y}—

wherein x, y are the number of each of the repeat units in the polymer or oligomer;
R is independently in each occurrence an aliphatic or heteroaliphatic, alicyclic or heteroalicyclic or aromatic or heteroaromatic group, preferably R is an aliphatic group of 2 to 14, preferably 3-5 carbon atoms,
R is a bond or an aliphatic group, preferably of 1 to 12, more preferably 2-6 carbon atoms,
R″ is an aliphatic or heteroaliphatic, alicyclic or heteroalicyclic or aromatic or heteroaromatic group. Preferably, R″ is an aliphatic group of 1 to 8, more preferably 2 to 6, carbon atoms; and
Ra is a bond or is an aliphatic or heteroaliphatic, alicyclic or heteroalicyclic or aromatic or heteroaromatic group, preferably Ra is an aliphatic group of 1 to 10, preferably 2-4 carbon atoms.

The polymer or oligomer of embodiment II preferably has a molecular weight (Mn) of at least about 1000 g/mol and no more than about 30,000 g/mol, more preferably at least about 2000 g/mol and no more than about 20,000 g/mol. The polymer or oligomer of embodiment II preferably has a molecular weight (Mn) of at least about 5000 g/mol and no more than about 18,000 g/mol. More preferably, the molecular weight is no more than about 12,000 g/mol.

A preferred self-assembling material according to embodiment II is a polymer or oligomer of formula II-1:

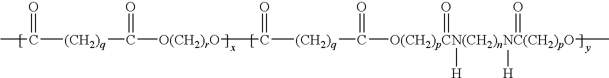

wherein p, q, and r are independently 2, 3, 4, 5, 6 or 8;
n is 2-6;
and x and y are such that the molecular weight of the polymer or oligomer (Mn) is between about 1000 g/mol and 30,000 g/mol, preferably between about 2000 g/mol and 20,000 g/mol.

A preferred self-assembling material according to embodiment II is a polymer or oligomer of formula II-1 wherein p, q, and r are independently 2, 4, 5, or 6 and Mn is between about 5000 g/mol and 12,000 g/mol. In formula II-1, it is preferred that q and r at each occurrence are 4. Also preferably, p at each occurrence is 5. Also preferably, n is 2.

A further preferred polymer or oligomer according to embodiment II is a polymer or oligomer of the formula II-2:

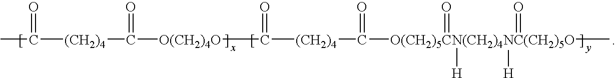

In a further preferred embodiment (embodiment III), the polymer or oligomer is a poly(ester-amide) comprising the formula:

—[O—R″O—C(O)R′C(O)]ₓ—[ORO—C(O)—RC(O)N(H)RaN(H)C(O)RC(O)]_{y}—

wherein
R is independently in each occurrence an aliphatic or heteroaliphatic, alicyclic or heteroalicyclic or aromatic or heteroaromatic group, preferably R is an aliphatic group of 1 to 10, preferably 1-6 carbon atoms,
R is a bond or an aliphatic group, preferably of 1 to 10, more preferably 2-6 carbon atoms,
R″ is an aliphatic or heteroaliphatic, alicyclic or heteroalicyclic or aromatic or heteroaromatic group. Preferably, R″ is an aliphatic group of 1 to 8, more preferably 2 to 6, carbon atoms; and
Ra is a bond or is an aliphatic or heteroaliphatic, alicyclic or heteroalicyclic or aromatic or heteroaromatic group, preferably Ra is an aliphatic group of 1 to 10, preferably 1-4 carbon atoms.

The polymer or oligomer of embodiment III preferably has a molecular weight (Mn) of at least about 1000 g/mol and no more than about 30,000 g/mol, more preferably at least about 2000 g/mol and no more than about 20,000 g/mol, still more preferably at least about 5000 g/mol, and no more than about 18,000 g/mol. More preferably, the molecular weight is no more than about 12,000 g/mol.

A preferred self-assembling material according to embodiment III is a polymer or oligomer of formula III-1:

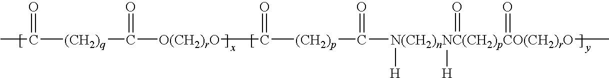

wherein p, q, and r are independently 2, 4, 5, 6, or 8;
n is 2-6
and x and y are such that the molecular weight (Mn) of the polymer or oligomer is between about 1000 g/mol and 30,000 g/mol, preferably between about 2,000 g/mol and 20,000 g/mol.

A preferred self-assembling material according to embodiment II is a polymer or oligomer of formula III-1 wherein p, q, and r are independently 2, 4, 5, or 6 and Mn is between about 5000 g/mol and 12,000 g/mol. In formula III-1, it is preferred that p, q and r at each occurrence are 4. Also preferably, n is 4.

A further preferred polymer or oligomer according to embodiment III is a polymer or oligomer of the formula III-2:

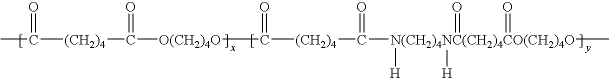

In yet another preferred embodiment (embodiment IV), the polymer or oligomer is a poly(ester-urethane) comprising the formula:

—[C(O)R′C(O)O—R″O]ₓ—[C(O)R′C(O)O—ROC(O)N(H)RaN(H)C(O)ORO]_{y}—

wherein:
R is independently at each occurrence an aliphatic or heteroaliphatic, alicyclic or heteroalicyclic or aromatic or heteroaromatic group, preferably R is an aliphatic group of 1 to 10, preferably 2-4 carbon atoms,
R′ is independently at each occurrence a bond or an aliphatic group, preferably of 1 to 10, more preferably 2-4 carbon atoms,
R″ is an aliphatic or heteroaliphatic, alicyclic or heteroalicyclic or aromatic or heteroaromatic group. Preferably, R″ is an aliphatic group of 1 to 8, more preferably 2 to 4, carbon atoms; and
Ra is a bond or is an aliphatic or heteroaliphatic, alicyclic or heteroalicyclic or aromatic or heteroaromatic group, preferably Ra is an aliphatic group of 1 to 12, preferably 2-6 carbon atoms.

The polymer or oligomer of embodiment IV preferably has a molecular weight (Mn) of at least about 1000 g/mol and no more than about 30,000 g/mol, more preferably at least about 2,000 g/mol, and no more than about 20,000 g/mol. The polymer or oligomer of embodiment IV preferably has a molecular weight (Mn) of at least about 5,000 g/mol, and no more than about 18,000 g/mol. More preferably, the molecular weight is no more than about 12,000 g/mol.

In the formulas of the polymers or oligomers described herein, variables x and y are integers greater than 1 and are independently selected such that Mn is 30,000 or less.

In filtration applications, preferably the oligomer has a Mn of from 1000 g/mol to about 5500 g/mol, preferably from 1000 g/mol to 5000 g/mol, more preferably less than 5000 g/mol.

The self assembling materials described above can be prepared as described in U.S. Pat. No. 6,172,167 and/or in international application number PCT/US2006/023450.

U.S. Pat. No. 6,172,167 teaches a process for producing aliphatic polyester-amide polymers having the formula HO-D1-O—[—CO-AA1-CO—O-D1-O-]x-[CO-AA1-CO—O-AD-O]y-H, wherein O-D1-O represents a diol functionality, wherein CO-AA1-CO represents a short (preferably 6 or fewer carbon atoms) aliphatic dicarboxylic acid functionality, wherein O-AD-O represents a short (e.g. preferably 6 or fewer carbon atoms in the diamine) symmetrical, crystallizing amid diol functionality, wherein x and y are the number of repeat units in the polymer block inside the brackets.

As taught in U.S. Pat. No. 6,172,167, such polymers can be made from reaction mixtures comprising an amide diol. Amide diols which are particularly useful in the practice of the instant invention have the following structure;

HO—(CH₂)ₙ—CONH—(CH₂)ₘ—(X)ₖ—(CH₂)ₘ—CONH—(CH₂)ₙ—OH

wherein X is NH, O or S, k is from 0 to 1, m is from 1 to 4 and n is from 4 to 6.

The amide diol can be prepared by any suitable means, however it has been found advantageous to prepare the amide diol by the ring opening polymerization (ROP) reaction between at least one primary diamine and at least one lactone. The preparation of the amide diol can also be carried out according to the methods described in U.S. Pat. No. 3,025,323 and in “Synthesis of Alternating Polyamideurethans by Reacting Diisocyanates with N,N′-Di-(6-hydroxycaproyl)alkylenediamines and N-hydroxy-alkyl-6-hydroxycaproamide” by S. Katayama et al. in J. Appl. Polym. Sci., Vol. 15, 775-796 (1971).

A primary diamine is defined in this specification as an organic compound comprising two primary amine groups. The primary diamine may also comprise secondary and tertiary amines groups. Suitable diamines are ethylene diamine, diethylene triamine, butane diamine and hexane diamine.

The lactone preferably has 4, 5 or 6 carbon atoms. Suitable lactones include γ-butyrolactone, δ-valerolactone, ε-caprolactone, pentadecalactone, glycolide and lactides. The preferred method of carrying out such reaction is to mix, in a stainless steel stirred-tank reactor, the lactone with the diamine in a ratio of at least 2 mol of lactone per mol of diamine, preferably in a ratio of 2.0 to 2.5 mol of lactone per mol of diamine. The reaction is preferably carried out under a nitrogen blanket. The reactants may be dissolved in a solvent, but generally it is preferable to carry out the reaction in the absence of a solvent in order to eliminate the effort required in separating the solvent from the polymer composition product. Preferably the reaction temperature is maintained at a temperature which is lower than the melting point of the pure amide diol, preferably between 0 degrees Celsius (° C.) and 30° C. lower than the melting point, which generally results in a product comprising a high fraction of the desired amine diol product which can be used in subsequent process steps without the need for further purification. If the reaction is carried out in the absence of a solvent the whole contents of the reactor will generally solidify. It is generally advantageous to allow the reaction mixture cool down to ambient temperature and to allow the reaction product to stand for a several hours, preferably for more than 6 hours, more preferably for more than 12 hours to allow any remaining diamine to react. The amide diol product may then be removed from the reactor by heating the reactor contents, preferably under a suitable inert gas blanket, until the product melts.

A particularly preferred amide diol is the condensation product prepared from ethylene diamine and ε-caprolactone, coded C2C in the examples and which has the following structure:

HO—(CH₂)₅—CONH—(CH₂)₂—NHCO—(CH₂)₅—OH

The aliphatic polyester-amide polymer can be made by contacting an amide diol with a low molecular weight dicarboxylic acid diester and a low molecular weight diol, heated to liquefy the mixture after which the catalyst is injected.

Low molecular weight dicarboxylic acid diesters are defined as having a molecular weight less than 258 grams per mole. The alkyl moieties of the dicarboxylic acid diester are preferably the same or different and have between 1 and 3 carbon atoms. Preferably the alkyl moieties are methyl groups. The dicarboxylate moiety of the dicarboxylic acid diester preferably has between 2 and 8 carbon atoms, most preferably between 4 and 6 carbon atoms. Preferably the dicarboxylate moiety is a succinate, glutarate or adipate group. Suitable dicarboxylic acid esters include dimethyl succinate, dimethyl adipate, dimethyl oxalate, dimethyl malonate and dimethyl glutarate.

Generally the reaction is carried out in a stirred heated reactor or devolitizer, fitted with a reflux column, under an inert gas blanket. In a preferred embodiment solid amide diol is first mixed with the dicarboxylic acid diester. The mixture of amide diol and dicarboxylic acid diester is then slowly heated up to a temperature of about 140° C. or until such temperature that the amide diol dissolves completely. The mixture of amide diol and dicarboxylic acid diester mixture is then maintained at this temperature for 1.5 to 3 hours. To minimize discoloration the bis-amide diol is first mixed with dimethyl adipate at ambient temperature and then the mixture is heated to make it liquid and at the same time it is believed that the most reactive free amine functions are captured by transamidation reaction with dimethyl adipate to amide functions. Then the diol is added and finally the catalyst (at a moment when the most aggressive species are believed to have reacted away. The low molecular weight diol is introduced in stoichiometric excess, the mixture is homogenized and finally the catalyst is injected to form the aliphatic polyester-amide pre-polymer having a number average molecular weight less than 2000 g/mol.

Volatile diols are defined in this specification as having a molecular weight of less than 1,8-octane diol. Suitable diols include monoethylene glycol, 1,3-propanediol, 1,4-butanediol, 1,5 pentane diol, 1,6 hexane diol and 1,7 heptane diol. The volatile diol is added to the polymer and the mixture is generally homogenized by continuous stirring. The temperature is generally maintained at or above the melting temperature of the amide diol, typically at about 140° C. The reaction is preferably carried out under an inert gas blanket at about atmospheric pressure. A catalyst is then preferably added to the reactant mixture. Any suitable compound for catalyzing transesterification and transamidification reactions may be used. Suitable catalysts include tetrabutoxy titanium (IV), zinc acetate and magnesium acetate.

The addition of the volatile diol and optional catalyst results in the evolution of a vapor comprising the low molecular weight alcohol or alcohol mixture corresponding to the alkyl moiety or moieties of the dicarboxylic acid esters, and the formation of the pre-polymer. The vapor formed is distilled off at about atmospheric pressure from the reaction mixture comprising the pre-polymer. The reaction is continued until the evolution of alcohol subsides.

In a second stage of the polycondensation process the reaction is continued in a devolatizer reactor under reduced pressure to completely remove the free volatile diols and to increase the molecular weight and convert the pre-polymer with molecular weight less than 2000 g/mol to a full polyester amide polymer with molecular weight higher than 1000 g/mol, preferably higher than 4000 g/mol. At this point in time other reactive species like non-volatile diols can be admixed as to further increase the molecular weight or to introduce specific properties like branching or hydrophobic interactions.

A polymer of the formula HO-D2-O—[—CO-AA1-CO—O-D1,2-O-]x-[CO-AA1-CO—O-AD-O]y-H can be made by contacting an aliphatic polyester-amide polymer having the formula HO-D1-O—[—CO-AA1-CO—O-D1-O-]x[CO-AA1-CO—O-AD-O]y-H with a nonvolatile diol having the formula HO-D2-OH to form a mixture, the temperature of the mixture being sufficiently high to produce the polymer.

A polymer of the formula HO-D1-O—[—CO-AA1-CO—O-D1-O-]x-[CO-AA1-CO—O-AD-O]y—CO-AA1-CO—O-M-(O—[CO-AA1-CO—O-D1]ₓ—O—[CO-AA1-CO—O-AD-O]y-H)ₙ₋₁ can be made by contacting an aliphatic polyester-amide polymer having the formula HO-D1-O—[—CO-AA1-CO—O-D1-O-]x-[CO-AA1-CO—O-AD-O]y-H with a polyol having the formula M-(OH)ₙ to form a mixture, wherein n is 3 or more, the temperature of the mixture being sufficiently high to produce the polymer. M in the polyol M-(OH)ₙ is an n valent organic moiety, preferably aliphatic or heteroaliphatic, alicyclic or heteroalicyclic or aromatic or heteroaromatic group, preferably having up to 20 carbon atoms. More preferably, M is aliphatic. Preferred examples of M-(OH)ₙ include glycerine, trimethylolpropane, pentaerythritol, methylglucoside, sorbitol, and ethoxylated and propoxylated derivatives of those molecules.

A polymer of the formula HO-D1-O—[—CO-AA1-CO—O-D1-O-]x-[CO-AA1-CO—O-AD-O]y—CO-PA-(CO—O-D1-[O—OC-AA1-CO—O-D1-O]x-[CO-AA1-CO—O-AD-O]y-H)ₙ₋₁ can be made by contacting an aliphatic polyester-amide polymer having the formula HO-D1-O—[—CO-AA1-CO—O-D1-O-]x-[CO-AA1-CO—O-AD-O]y-H with a polyacid ester having the formula PA-(CO—ORb)ₙ to form a mixture, wherein n is 3 or more, the temperature of the mixture being sufficiently high to produce the polymer. PA in the polyacid ester PA-(CO—ORb)ₙ is an n valent organic moiety, preferably aliphatic or heteroaliphatic, alicyclic or heteroalicyclic or aromatic or heteroaromatic group, preferably having up to 20 carbon atoms. Preferred PA include 1,3,5 benzene tricarboxylic acid; citric acid, agaric acid, and aconitic acid. Rb is an aliphatic group of 1-10 carbon atoms, preferably 1-6 carbons, more preferably —CH3, —CH2-CH3, propyl or isopropyl.

A polymer of the formula HO-D1-O—[—CO-AA1,2-CO—O-D1-O-]x-[CO-AA1,2-CO—O-AD-O]y-H can be made by contacting an aliphatic polyester-amide polymer having the formula HO-D1-O—[—CO-AA1-CO—O-D1-O-]x-[CO-AA1-CO—O-AD-O]y-H with a high boiling point diacid ester having the formula RO—CO-AA2-CO—OR to form a mixture, the temperature of the mixture being sufficiently high to produce the polymer.

A polymer of the formula HO-D2-O—[—CO-AA1-CO—O-D1,2-O-]x-[O-D1,2-O—CO-DD-CO]y-OH can be made by contacting a pre-polymer having the formula HO-D1-O-[—CO-AA1-CO—O-D1-O-]x-[O-D1-O—CO-DD-CO]y-OH, wherein O-D1-O represents the residual of a volatile diol functionality, wherein O—CO-DD-CO—O represents the residual of a short (e.g. preferably 6 or fewer carbon atoms) symmetrical, crystallizing diamide diacid functionality, with a nonvolatile diol having the formula HO-D2-OH to form a mixture, the temperature of the mixture being sufficiently high to produce the polymer.

A polymer of the formula HO-D1-O—[—CO-AA1-CO—O-D1-O-]x-[O-D1-O—CO-DD-CO—]_{y}—O-M-(O—[CO-AA1-CO—O-D1]x-O—[O-D1-O—CO-DD-CO]y-OH)ₙ₋₁ can be made by contacting a polymer having the formula HO-D1-O—[—CO-AA1-CO—O-D1-O-]x-[O-D1-O—CO-DD-CO]y-OH with a polyol having the formula M-(OH)ₙ to form a mixture, wherein n is 3 or more, the temperature of the mixture being sufficiently high to produce a the polymer.

A polymer of the formula HO-D1-O—[—CO-AA1-CO—O-D1-O-]x-[OC-DD-CO—O-D1-O]_{y} OC-PA-([—CO—O-D1-O—CO-AA1-CO-]ₓ[O-D1-O—CO-DD-CO]y-OH)ₙ₋₁ can be made by contacting a polymer having the formula HO-D1-O—[—CO-AA1-CO—O-D1-O-]x-[O-D1-O—CO-DD-CO]y-OH with a polyacid ester having the formula PA-(CO—OR)ₙ to form a mixture, wherein n is 3 or more, the temperature of the mixture being sufficiently high to produce the polymer.

A polymer of the formula HO-D1-O—[—CO-AA1,2-CO—O-D1-O-]x-[CO-AA1,2-CO—O—CO-DD-CO]y-OH can be made by contacting a polymer having the formula HO-D1-O-[—CO-AA1-CO—O-D1-O-]x-[O-D1-O—CO-DD-CO]y-OH with a high boiling point diacid ester having the formula RO—CO-AA2-CO—OR to form a mixture, the temperature of the mixture being sufficiently high to produce the polymer.

The short symmetrical, crystallizing diamide diacid functionality herein is the same as defined and taught in the above-referenced U.S. Pat. No. 6,172,167. A particularly preferred diamide diacid functionality is the condensation product prepared from ethylene diamine and dimethyl adipate, coded A2A in the examples.

In this specification high boiling point dicarboxylic acid diesters are defined as aliphatic dicarboxylic acid diesters having a molecular weight greater than 202 g/mol. The alkyl moieties of the dicarboxylic acid diester are preferably the same or different and have between 1 and 3 carbon atoms. Preferably the alkyl moieties are methyl groups. The dicarboxylic acid moiety preferably has between 7 and 10 carbon atoms, most preferably either 9 or 10 carbon atoms. Preferably the dicarboxylic acid moiety is an azelate or sebacate group. Preferred dicarboxylic acid esters are dimethyl azelate, dimethyl sebacate and dimethyl suberate.

Suitable nonvolatile diols in the instant invention include higher glycols such as dipropylene glycol or tripropylene glycol, polyethylene glycols (PEG's of molecular weight 400 g/mol to 8000 g/mol) and EO capped polypropylene glycols of molecular weight 400 g/mol to 4000 g/mol), dimer diols or Soy polyols or other high molecular weight natural diols like mentioned in Jetter et al. Phytochemistry 55, 169-176 (2000). Polyols suitable for use in the instant invention include glycerol, trimethylol propane, sorbitol and sucrose.

The reaction of the aliphatic polyester-amide polymer with the nonvolatile diol, the polyol, polyacid ester or the high boiling point dicarboxylic acid diester is generally carried out under an inert gas blanket. The mixture is then heated over a period of typically 2 to 3 hours to a temperature of about 180° C. or to such temperature that the resulting amide ester polymer remains in the molten or dissolved state. The pressure is typically about atmospheric pressure. The reaction can result in the evolution of low molecular weight alcohol which is removed by distillation from the system.

The pressure in the reactor is then gradually lowered to an absolute pressure of about 5 millibar to initiate the distillation under vacuum of any remaining volatile materials. The resulting polymer composition can then be cooled to about 150° C. and brought to atmospheric pressure, after which the polymer may be removed from the reactor whilst still in the molten state.

The polymers described above can be modified with, for example and without limitation thereto, other polymers, resins, tackifiers, fillers, oils and additives (e.g. flame retardants, antioxidants, processing aids, pigments, dyes, and the like).

As used herein, the term “aliphatic” refers to hydrocarbons which are saturated or unsaturated (alkanes, alkenes, alkynes) and which may be straight-chain or branched. Preferably, aliphatic is saturated alkane. Aliphatic groups can be optionally substituted with various substituents or functional groups, including among others halides, hydroxy groups, thiol groups, ester groups, ketone groups, carboxylic acid groups, amines, and amides. A “heteroaliphatic” group is an aliphatic group that contains one or more non-carbon atoms in the hydrocarbon chain (e.g., one or more non-neighboring CH₂ groups are replaced with O, S or NH).

The term “alicyclic” refers to hydrocarbons that have one or more saturated or unsaturated rings (e.g., three to ten-membered rings) and which may be bicyclic. Alicyclic groups can include portions that are branched and/or straight-chain aliphatic in combination with cyclic hydrocarbon. Alicyclic groups can be substituted, as noted above for aliphatic groups. A “heteroalicyclic” group is an alicyclic group that contains one or more heteroatoms (non-carbon atoms) in the hydrocarbon chain, in a ring or in a straight-chain or branched aliphatic portion of the alicyclic group (e.g., one or more non-neighboring CH₂ groups can be replaced with O, S or NH).

The term “aromatic” refers to hydrocarbons that comprise one or more aromatic rings which may be fused rings (e.g., as in a naphthalene group). Aromatic groups can include portions that are branched and/or straight-chain aliphatic and/or alicyclic in combination with aromatic. Aromatic groups can be substituted, as noted above for aliphatic groups. A “heteroaromatic” group is an aromatic group that contains one or more heteroatoms (non-carbon atoms) in an aromatic ring (e.g., a pyridine ring). A CH in an aromatic ring can be replaced with O, S or N. In any alicyclic or aliphatic portion of an aromatic group, one or more non-neighboring CH₂ groups can be replaced with a heteroatom (e.g., O, S, NH).

In another aspect according to the present invention the material has a tensile modulus of at least 15 MPa, preferably between 50 and 500 MPa when the modulus of a compression molded sample of the bulk material is tested in tension. From material according to certain embodiments, 2 mm thick compression molded plaques useful for tension-type testing (e.g., “Instron” tensile testing as would be know in the art) were produced. Prior to compression molding, the materials were dried at 65° C. under vacuum for about 24 hours. Plaques of 160×160×2 (mm) were obtained by compression molding isothermally at 150° C., 6 minutes at 10 bar (ca. 1.0 MPa) and afterwards 3 minutes at 150 bar (ca. 15 MPa). The samples were cooled from 150° C. to room temperature at a cooling rate of 20° C./min. Some preferred embodiments exhibit Newtonian viscosity over an oscillating test range frequency of 10⁻¹ to 10² radians per second at temperatures from above Tm up to about 40° C. above Tm. Depending upon the polymer or oligomer, these self-assembling materials preferably exhibit Newtonian viscosity in the test range frequency at temperatures above 100° C., more preferably above 120° C. and more preferably still at or above 140° C. and preferably less than 300° C., more preferably less than 250° C. and more preferably still less than 200° C. For one preferred embodiment the relevant temperature range is between about 140° C. and 200° C. and above. Certain preferred embodiments of the invention have exhibit mechanical properties in the solid state of conventional high molecular weight fiber polymers, for example Tensile modulus (of molded samples) of from 15 to 500 MPa and some rheological properties of low molecular weight Newtonian liquids to facilitate faster processing rates. For the purposes of the present disclosure the term Newtonian has it conventional meaning; that is, approximately a constant viscosity with increasing (or decreasing) shear rate of a material. The self-assembling, materials disclosed herein, preferably low Mn, advantageously possess low melt viscosities useful for high output (relative to traditional high polymer electrospinning) fiber electrospinning and utilities in submicron-fiber form. In preferred embodiments, the zero shear viscosity of the self assembling material is in the range of from 0.1 to 30 Pa.sec., more preferred 0.1-10 Pa.sec., between the temperature range of 180 and 190 degrees ° C.

In one preferred aspect according to a process of the present invention, fibers are produced that have an average diameter of about 1000 nanometers or less and the fibers are produced at a rate, expressed in grams per minute (g/min), greater than a solvent-normalized rate, but at least 2 times, more preferably at least 5 times, more preferably at least 10 times, and up to 50 times, the solvent-normalized rate, expressed in g/min, of producing corresponding diameter fibers from the self assembling material with a solvent-based electrospinning process. The term “corresponding diameter fibers” means solvent-based electrospun fibers having about the same (e.g., within 50%, preferably within 25%, more preferably within 15%) average diameter as the average diameter of the fibers produced by the invention process. The term “solvent-normalized rate” is calculated by dividing the actual rate of the solvent-based electrospinning process by the weight percent concentration (e.g., 0.05 for 5 wt %) of the self assembling material mixed in the solvent. For present purposes, weight percent is calculated by dividing the weight of the same self assembling material by the sum of the weight of the same self assembling material plus weight of the solvent.

### Melt Electrospinning

The technique of electrospinning fiber-forming materials is known and has been described in a number of patents and the general literature. Use of commercially available electrospinning devices, such as those available from NanoStatics™, LLC, Circleville, Ohio, USA; and Elmarco s.r.o., Liberec, Czech Republic (e.g., using Nanospider™ technology), are preferred.

A typical electrospinning apparatus for use in the invention includes three primary components: a high voltage power supply, a spinneret, and a collector (effectively a grounded conductor). The spinneret is a spin electrode that allows for extracting fibers by way of an electric field. It can be a syringe, a cylinder rotating in a melt, a capillary device or a conductive surface, that is connected to a feeding system for introducing the fiber-forming self-assembling material useful in the present invention. A preferred system uses a pump to control the flow of the material out of, for example, a syringe nozzle allowing the material to form a Taylor cone.

The self assembling material in melted form is fed into or onto the spinneret from, for example, the syringe at a constant and controlled rate using a metering pump. A high voltage (e.g., 1 to 50 kV) is applied and the drop of polymer at the nozzle of the syringe becomes highly electrified. At a characteristic voltage the droplet forms a Taylor cone, and a fine jet of polymer develops. The fine polymer jet is drawn to the grounded collector which is placed opposing the spinneret. While being drawn to the collector, the jet cools and hardens into fibers. The fibers are deposited on the collector as a randomly oriented, non-woven mat or individually captured and wound-up on a roll. The fibers are subsequently stripped from the collector.

The parameters for operating the electrospinning apparatus for effective melt spinning of the materials of the invention can be readily determined by a person of ordinary skill in the art without undue experimentation. By way of example, the spinneret can be generally heated up to about 300° C., the spin electrode temperature is maintained at about 10° C. above the melting point or temperature at which the self assembling material has sufficiently low viscosity to allow thin fiber formation, and the surrounding environmental temperature maintained at about similar temperatures using hot air. The applied voltage is generally about 1 to 120 kV, preferably 1-80 kV. The electrode gap (the gap between spin electrode and collector) is generally between about 3 cm and about 50 cm, preferably about 3 and about 19 cm. Preferably, the fibers can be fabricated at about ambient pressure (e.g., 1.0 atmosphere) although the pressure can be higher or lower.

The fibers prepared by the process described above generally have an average diameter of about 1000 nm or less, more preferably about 800 nm or less, and more preferably about 600 nm or less. Preferably, the average diameter of the fibers is at least 100 nm, more preferably at least 200 nm. In other aspects, the fibers have an average diameter of about 30 to about 1000 nm, more preferably about 200 to about 600 nm. In other aspects, the fibers have an average diameter of about 50 to about 1000 nm. Fibers can be fabricated with diameters as low as about 30 nm. Particularly preferred are fibers with average diameters of about 200-300 nm.

Preferably, average fiber diameter for a plurality of fibers can be determined by processing a scanning electron microscopy image thereof with, for example, a QWin image analysis system (Leica Microsystems GmbH, 35578 Wezlar, Germany).

The following Examples are illustrative of the invention but are not intended to limit its scope.

### EXAMPLES

### Preparation of the amide diol ethylene-N,N″-dihydroxyhexanamide (C2C)

C2C monomer is prepared by reacting 1.2 kg ethylene diamine (EDA) with 4.56 kg of ε-caprolactone under a nitrogen blanket in a stainless steel reactor equipped with an agitator and a cooling water jacket. An exothermic condensation reaction between the ε-caprolactone and the EDA occurs which causes the temperature to rise gradually to 80 degrees Celsius (° C.). A white deposit forms and the reactor contents solidify, at which the stirring is stopped. The reactor contents are then cooled to 20° C. and are then allowed to rest for 15 hours. The reactor contents are then heated to 140° C. at which temperature the solidified reactor contents melt. The liquid product is then discharged from the reactor into a collecting tray. A nuclear magnetic resonance study of the resulting product shows that the molar concentration of C2C in the product exceeds 80 percent. The melting point of the C2C product is determined to be 140° C.

Contacting C2C with Dimethyl Adipate.

A devolitizer reactor is charged with 2.622 kg liquid dimethyl adipate and 2.163 kg of the solid C2C diamide diol produced as described above. The reactor contents are brought slowly under nitrogen purge to a temperature of 140° C. in order to melt the C2C in the reaction mixture.

Contacting the Composition with 1,4-butanediol without Further Addition of Non Volatile Diols, Acids or Branching Agents.

1.352 kg of 1,4-butanediol are added to the reactor contents followed by 105 milliliters (mL) of a 10 percent by weight solution of tetrabutoxy titanium (IV) in 1,4-butanediol. The resulting reaction results in the formation of methanol which is then removed as vapor by the nitrogen purge from the reactor system. The pressure in the system is maintained at atmospheric pressure, and temperature is gradually raised to 180° C. The reaction and distillation of methanol is continued until the evolution of methanol subsides. The pressure in the reactor is then lowered to an absolute pressure of 450 mbar and then stepwise to 20 mbar, resulting in further evolution of methanol vapor from the reaction mixture. When the flow of methanol subsides the pressure in the reactor is further lowered an absolute pressure of 0.25 mbar to initiate distillation of 1,4-butanediol, and the temperature in the reactor is gradually increased to 200° C. When 710 mL of 1,4-butanediol has been recovered from the reactor, the vacuum in the reactor is broken and the resulting molten amide ester polymer composition is discharged from the reactor.

The above procedure is repeated to prepare six different batches of amide ester polymer compositions at 50 mole % C2C content calculated on the total amount of diols incorporated in the polymer structure (coded P1, P3, P4, P7, P8 and P9 respectively) having the following physical properties recited in TABLE 1.

TABLE 1

| | Molecular | | Melt viscosity | Ultimate | | |
|---|---|---|---|---|---|---|
| | weight (Mₙ) | Melting | (Pa · s) (at | tensile | | Tensile |
| Product | based on | point | temperature | strength | Elongation | Modulus |
| code | NMR | (° C.) | ° C.)* | (MPa) | to break (%) | (MPa) |
| P1 | 16,000 | 127 | 18 (180° C.) | 17 | 700 | 240 |
| P3 | 19,000 | 132 | 21 (180° C.) | 21 | 735 | 279 |
| P4 | 10800 | 124 | 18 (160° C.) | 17 | 840 | 290 |
| | | | 9.5 (180° C.) | | | |
| P7 | 9000 | 123 | 12 (160° C.) | 15 | 725 | 290 |
| | | | 7.7 (180° C.) | | | |
| P8 | 11800 | 122 | 24 (160° C.) | 23 | 970 | 260 |
| | | | 14.7 (180° C.) | | | |
| P9 | 8500 | 118 | 7 (160° C.) | 12 | 640 | 230 |
| | | | 4.5 (180° C.) | | | |

*measured with Brookfield viscometer using spindle Nr. 3 at 5 revolutions per minute (rpm)

In some embodiments of the invention, the melt viscosity exhibits Newtonian behavior up to number average molecular weight of 20,000 g/mol.

Preparation of di-amide di-ester monomer A2A:

In a nitrogen atmosphere, titanium (IV) butoxide (0.92 g, 2.7 mmol), ethylene diamine (15.75 g, 0.262 mol), and dimethyl adipate (453.7 g, 2.604 mol) are loaded into a 3-neck, 1 L round bottom flask that is stoppered and transferred to hood. Flask is placed under positive nitrogen via inlet adaptor attached to a Firestone valve. Stir-shaft with blade is inserted into flask along with stir bearing with overhead stir motor. Stoppered condenser is inserted into flask. A thermocouple inserted thru septa is also inserted into the flask. Flask is warmed with a hemisphere heating mantle that is attached to proportional temperature controller. Basic reaction profile is 2.0 hours to/at 50 C, 2.0 hours to/at 60 C, 2.0 hours to/at 80 C; overnight at 100 C. Flask is slowly cooled with stirring to ˜50 C, stirring stopped and cooled to ˜room temperature. Approximately 200 mL of cyclohexane are added to flask with agitation for a filterable slurry with solid collected on a medium porosity glass filtration funnel. Collected solids are washed twice with ˜50 mL of cyclohexane. Product is dried overnight in a ˜50 C vacuum oven. Dried product is broken up and re-slurried in fresh cyclohexane (˜300 mL), recollected by filtration, rinsed twice with ˜50 mL cyclohexane, and dried to constant weight in a 50 C vacuum oven under full pump vacuum. Yield=59.8 grams (66%).

Contacting the A2A Monomer Composition with 1,4-butanediol (“1,4 BD”) without Further Addition of Non Volatile Diols, Acids or Branching Agents.

PBA A2A-50% (polyester amide with 50 mole % A2A monomer incorporation)

The devolatizer reactor is charged at room temperature (or 50-60° C.) with 348.4 gram (2.0 moles) of dimethyl adipate (DMA) followed by 680 gram (˜7.7 moles) 1,4 butane diol and 688.8 gram (2.0 moles) of A2A (powder); with nitrogen blanket. The kneader temperature is slowly brought to 140-150° C. under nitrogen purge to ensure complete solvation (clear solution) of the contents.

Then, still under nitrogen blanket and at 140-150° C., Ti(OBu)4 catalyst is injected as 41.5 gram of a 10% by weight solution in 1,4 BD (4000 parts per million (ppm) calculated on total esters; 4.15 g catalyst+37.35 g BD; total content of 1,4 BD is 717 g or 7.97 moles). At 140-150° C., methanol starts distilling. The reactor temperature is increased stepwise to 175° C. at atmospheric pressure; initially with low (to prevent entrainment of the monomers DMA and BD) nitrogen sweep applied. Methanol fraction is distilled off and collected (theoretical amount: 256 g, 8 moles) in a cooling trap. The purpose is to maintain a constant stream of methanol distilled. When the major fraction of methanol is removed at 175° C., the temperature is increased to 190° C. and the reactor pressure is stepwise decreased first slowly to 50-20 mbar (to avoid eventual foaming) and further to 5 mbar to complete the methanol removal and to initiate the 1,4 BD distillation. The pressure is further decreased <1 mbar, until the steady distillation of 1,4 butane diol is observed. At the end of the reaction the temperature is raised to 200-220° C. Calculated amount of 1,4 BD collected: 360 g (4 moles). When the 1,4 butane diol removal is completed, the reactor is cooled to ˜150° C. (depending on torque measured) and brought to atmospheric pressure under nitrogen blanket and the polymer is collected.

The following additional resins were produced according to the methods described above. The monomers C2C and A2A were incorporated at two levels each, specifically at 25 and 50 mole %. The materials are coded PEA-C2C 25% (i.e., polyesteramide-C2C 25 mole percent amide segment), PEA-C2C 50%, PEA-A2A 25% and PEA-A2A 50% respectively. Data are collected in TABLE 2 below. From each material 2 mm thick compression molded plaques were produced. Prior to compression molding, the materials were dried at 65° C. under vacuum for about 24 hours. Plaques of 160*160*2 mm were obtained by compression molding isothermally at 150° C., 6 minutes at 10 bar and afterwards 3 minutes at 150 bar. The samples were cooled from 150° C. to room temperature at 20° C./min. The physical property data are presented in the following TABLE 2.

TABLE 2

| | PEA C2C- | PEA C2C- | PEA A2A- | PEA A2A- |
|---|---|---|---|---|
| | 50%* | 25% | 50% | 25% |
| Tensile Modulus (MPa) | 370 | 155 | 360 | 130-140 |
| Tensile Strength (MPa) | 15-20 | 6 | 15 | 6-12 |
| Elongation (%) | 600-800 | 330 | 600 | 600-1200 |
| Crystallization T. (° C.)** | 115(s) | 65(w) | 140(w) | 125(w) |
| Melt viscosity @ 180 C. | 5-15 | 3-10 | 25-40 | 7-12 |
| in Pa · s | | | | |

*percentage refers to mole % amide segment
**Refers to the temperature of crystallization when cooled from the melt; crystallization in sharp (s) or wider (w) temperature range

Additional examples of the preparation of polymers suitable for use in the invention follow.

### Preparation of the Prepolymers

### Example A

Preparation of Prepolymer from C2C, Dimethyl Adipate, and 1,4-Butanediol. Under an inert atmosphere into a 250 mL round bottom flask is loaded titanium (IV) butoxide (0.194 grams, 0.571 mmol), N,N′-1,2-ethanediyl-bis[6-hydroxyhexanamide] (13.62 grams, 47.22 mmol), dimethyl adipate (65.80 grams, 0.3777 mol), and 1,4-butanediol (59.57 grams, 0.6611 mol). Polymerization reaction is run with overhead stirring, nitrogen/vacuum, heating, and use of a distillation head. Reaction profile is as follows: 2.0 hrs from 160° C. to/at 175° C., N2; 5 minutes, 450 Torr; 10 minutes, 50 Torr; 5 minutes, 40 Torr; 10 minutes, 30 Torr; 10 minutes, 20 Torr; 10 minutes, 15 Torr; 90 minutes, 10 Torr; 1.0 hour, 0.425 to 0.60 Torr. Upon cooling waxy solid has Tm=51° C. (55 J/g); inherent viscosity=0.090 dL/g (chloroform/methanol (1/1, w/w), 30.0° C., 0.5 dL/g); Mn via 1H-NMR˜1098; and ˜12 mol % C2C incorporation via 1H-NMR.

### Example B

Preparation of Prepolymer from A4A, Dimethyl Adipate, and 1,4-Butanediol:

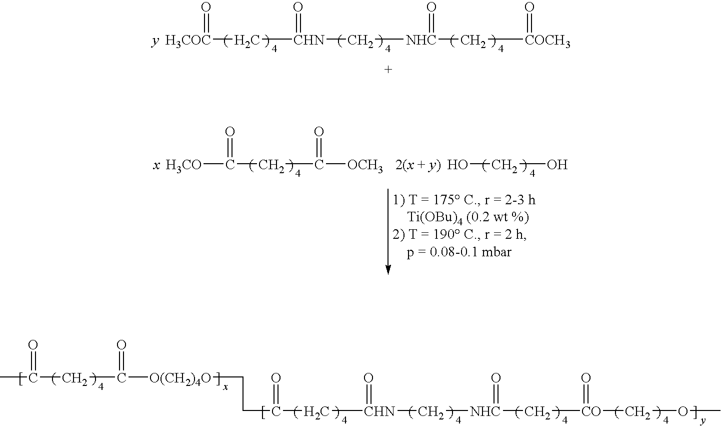

Under an inert atmosphere into a 250 mL round bottom flask is loaded titanium (IV) butoxide (0.174 grams, 0.512 mmol), dimethyl 7,12-diaza-6,13-dioxo-1,18-octadecanedioate (31.68 grams, 85.06 mmol), dimethyl adipate (44.45 grams, 0.2552 mol), and 1,4-butanediol (61.33 grams, 0.6805 mol). Polymerization reaction is run with overhead stirring, nitrogen/vacuum, heating, and use of a distillation head. Reaction profile is as follows: 2.0 hrs from 160° C. to/at 175° C., N2; 5 minutes, 450 Torr; 5 minutes, 100 Ton; 10 minutes, 50 Ton; 5 minutes, 40 Ton; 10 minutes, 30 Torr; 10 minutes, 20 Torr; 10 minutes, 15 Torr; 90 minutes, 10 Torr; 1.0 hour, ˜0.400 Torr. Upon cooling waxy solid has bimodal Tm=47 and 95° C.; inherent viscosity=0.091 dL/g (chloroform/methanol (1/1, w/w), 30.0° C., 0.5 dL/g); Mn via 1H-NMR˜1049; and ˜24 mol % A4A incorporation via 1H-NMR.

### Preparation of Polymers

### Example 1

Reaction of Prepolymer from C2C, Dimethyl Adipate, and 1,4-Butanediol with Polytetrahydrofuran. Under an inert atmosphere into a 250 mL round bottom flask is loaded titanium (IV) butoxide (0.091 grams, 0.27 mmol), prepolymer from Example A (40.00 grams), and polytetrahydrofuran (10.00 grams, 10.17 mmol, Mn 983, TERATHANE™1000). Polymerization reaction is run with overhead stirring, nitrogen/vacuum, heating, and use of a distillation head. Reaction profile is as follows: 1.0 hrs from 160° C. to/at 175° C., N2; 1.0 hours, 0.3 to 0.6 Ton, 175° C.; and 6 hours, ˜0.30 Torr, 190° C. Upon cooling tough solid has Tm=57° C. (28 J/g); inherent viscosity=0.60 dL/g (chloroform/methanol (1/1, w/w), 30.0° C., 0.5 dL/g); Mn via 1H-NMR˜16000 g/mol.

### Example 2

Reaction of Prepolymer from C2C, Dimethyl Adipate, and 1,4-Butanediol with Glycerol Ethoxylate. Into a 250 mL round bottom flask is loaded antimony oxide (0.0128 grams, 0.0439 mmol), calcium acetate monohydrate (0.0494 grams, 0.280 mmol), prepolymer from Example A (44.00 grams), glycerol ethoxylate (2.00 grams, 2.00 mmol, Mn 999). Polymerization reaction is run with overhead stirring, nitrogen/vacuum, heating, and use of a distillation head. Reaction profile is as follows: ˜1.8 hrs from 160° C. to/at 175° C., 0.2 to 0.9 Ton. Upon cooling tough solid has Tm=66° C. (40 J/g); inherent viscosity=0.27 dL/g (chloroform/methanol (1/1, w/w), 30.0° C., 0.5 dL/g).

### Example 3

Reaction of Prepolymer from A4A, Dimethyl Adipate, and 1,4-Butanediol with Dimethyl Sebacate. Into a 250 mL round bottom flask are loaded antimony oxide (0.0128 grams, 0.0439 mmol), calcium acetate monohydrate (0.0494 grams, 0.280 mmol), prepolymer from Example B (44.00 grams), and dimethyl sebacate (2.41 grams, 10.5 mmol). Polymerization reaction is run with overhead stirring, nitrogen/vacuum, heating, and use of a distillation head. Reaction profile is as follows: 2 hrs from 160° C. to/at 175° C., N2; 5 minutes, 450 Ton; 5 minutes, 100 Torr; 10 minutes, 50 Torr; 5 minutes, 40 Ton; 15 minutes, 30 Ton; 15 minutes, 20 Torr; 90 minutes, 10 Ton; 2 hrs, 0.4-0.6 Ton, 175° C.; 2.5 hrs, 0.3-0.4 Torr to/at 190° C. Upon cooling tough solid has bimodal Tm=69, 114° C. (43 J/g); inherent viscosity=0.28 dL/g (chloroform/methanol (1/1, w/w), 30.0° C., 0.5 dL/g); Mn via 1H-NMR˜7000 g/mol.

### Example 4

Reaction of Prepolymer from A4A, Dimethyl Adipate, and 1,4-Butanediol with Trimethyl 1,3,5-Benzenetricarboxylate. Into a 250 mL round bottom flask is loaded antimony oxide (0.0128 grams, 0.0439 mmol), calcium acetate monohydrate (0.0494 grams, 0.280 mmol), prepolymer from Example B (44.00 grams), and trimethyl 1,3,5-benzenetricarboxylate (0.529 grams, 2.10 mmol). Polymerization reaction is run with overhead stirring, nitrogen/vacuum, heating, and use of a distillation head. Reaction profile is as follows: 2.3 hrs from 160° C. to/at 175° C., N2; 5 minutes, 100 Ton; 10 minutes, 50 Ton; 5 minutes, 40 Torr; 15 minutes, 30 Ton; 15 minutes, 20 Torr; 90 minutes, 10 Torr; ˜2.5 hrs, 0.2-0.6 Torr. Upon cooling tough solid has bimodal Tm=73, 111° C. (44 J/g); inherent viscosity=0.29 dL/g (chloroform/methanol (1/1, w/w), 30.0° C., 0.5 dL/g).

### Example 5

Preparation of the polymer: A 2.5 liter kneader/devolatizer reactor is charged at 50-60° C. with 0.871 Kg of DMA (dimethyl adipate) and 0.721 Kg of bis-amide diol prepared by condensation of 1 mole EDA with two moles of e-caprolactone, with nitrogen blanket. The kneader temperature is slowly brought to 140-150° C. under nitrogen purge to obtain a clear solution. Then, still under nitrogen and at 140-150° C., 1,4 butane diol is loaded from the Feed cylinder 1: 0.419 Kg into the reactor and the mixture is homogenized by continued stirring at 140° C. Subsequently, Ti(OBu)4 catalyst is injected from Feed cylinder 2 as 34.84 gram of a 10% by weight solution in 1,4BD (4000 ppm calculated on DMA; 3.484 g catalyst+31.36 g BD; total content of 1,4 BD is 0.450 Kg). The kneader temperature is increased stepwise to 180° C. over a period of 2-3 hrs at atmospheric pressure; initially with low (to prevent entrainment of the monomers DMA and BD) nitrogen sweep applied. Methanol fraction is distilled off and collected (theoretical amount: 0.320 kg) in a cooling trap. When the major fraction of methanol is removed, the kneader pressure is stepwise decreased first to 50-20 mbar and further to 5 mbar to complete the methanol removal and to initiate the 1,4BD distillation. The pressure is further decreased <1 mbar or as low as possible, until the slow but steady distillation of 1,4 butane diol is observed (calculated amount 0.225 kg). During this operation the temperature is raised to 190-200° C. at maximum as to avoid discoloration. Towards the end of the reaction samples are taken from the reactor to check the viscosity. The target point is 2 Pa.s at 180° C. for a molecular weight of 5,000 g/mole. When the 1,4 butane diol removal is completed, the kneader is cooled to ˜150° C. (depending on torque measured) and brought to atmospheric pressure under nitrogen blanket and the polymer is collected as AMD PBA 18-05. From the polymer 2 mm thick compression molded plaques were produced. Prior to compression molding, the polymer was dried at 65° C. under vacuum for about 24 hours. Plaques of 160*160*2 mm were obtained by compression molding isothermally at 150° C., 6 minutes at 10 bar and afterwards 3 minutes at 150 bar. The samples were cooled from 150° C. to room temperature at 20° C./min Zero shear viscosity data are reported in TABLE 3. The data were obtained on the Advanced Rheometric Expansion System (ARES, TA Instruments, New Castle, Del., USA) with parallel plate setup. Dynamic Frequency Sweep tests were performed from 100 to 0.1 rad./sec. (10-30% strain) under nitrogen atmosphere. Properties are presented in TABLE 3.

TABLE 3

| | AMD PBA 18-05 |
|---|---|
| Tensile Modulus (MPa) | 180 |
| Tensile strength (MPa) | 5.7 |
| Elongation (%) | 16 |
| Tcrystallization (° C.) | 115 |
| Melt zero shear viscosity | |
| @140° C. (Pa · s) | 6.9 |
| @160° C. (Pa · s) | 3.6 |
| @180° C. (Pa · s) | 2.2 |
| @200° C. (Pa · s) | 1.5 |

PEA AMD 18-05 (granulated crude reactor material) was processed on electro-spinning equipment directly from the melt without any additives. The spin electrode consisting of a needle syringe filled with melt, is heated with two heating elements PID controlled, having a temperature range up to 300 C. Needle syringe temperature >135 C. Applied voltage 30 kV Environmental temperature is 20-150 C by hot air. Electrode gap is 3-19 cm. The fibrous material was collected on collector fabric.

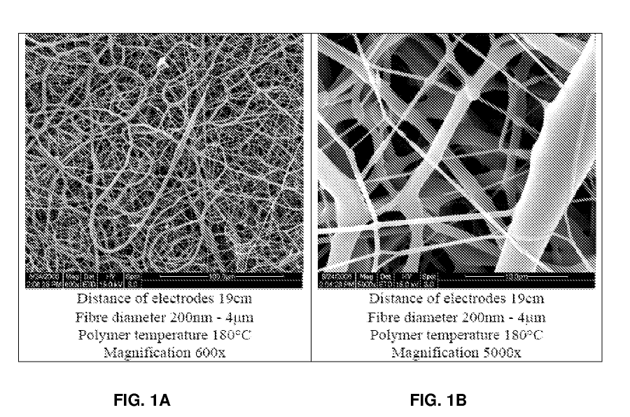

Result: Nano-fibers of ˜200-4000 nm were produced as shown in the SEM pictures of FIG. 1.

### CONCLUSION

While the invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

1. A process for fabricating fibers comprising electrospinning a melt of a self assembling material, wherein the self-assembling material of the fibers comprises oligomers or polymers comprising a supramolecular structure, the oligomers and polymers having repeat units that contain functional groups having directional interactions that are (a) electrostatic interactions (ion-ion, ion-dipole or dipole-dipole) or coordinative bonding (metal-ligand), (b) hydrogen bonding, (c) π-π stacking interactions, or (d) van der Waals forces, or a combination thereof, the supramolecular structure being formed upon a triggering event.

2. A process according to claim 1 wherein the self-assembling material is selected from the group consisting of a polyester-amide, polyether-amide, polyester-urethane, polyether-urethane, polyether-urea, polyester-urea, or a mixture thereof.

3. A process according to claim 1 wherein the number average molecular weight (Mn) of the self assembling material is between about 1000 grams per mole (g/mol) and about 30,000 g/mol.

4. (canceled)

5. A process according to claim 1 wherein the self assembling material comprises self assembling units comprising multiple hydrogen bonding arrays.

6-9. (canceled)

10. A process according to claim 5 wherein the self assembling units comprise a bis-amide, bis-urethane or bis-urea unit or their higher oligomers.

11. A process according to claim 1 wherein the self-assembling material is selected from the group consisting of:
a) a polymer or oligomer comprising repeat units -[H1-AA]- and -[DV-AA]-, where H1 is —R—CO—NH—Ra—NH—CO—R—O— or —R—NH—CO—R—CO—NH—R—O— where Ra is R or a bond, R is independently in each occurrence an aliphatic or heteroaliphatic, alicyclic or heteroalicyclic or aromatic or heteroaromatic group, AA is a —CO—R′—CO—O— where R′ is a bond or an aliphatic group, where DV is -[R″—O]- and R″ is an aliphatic or heteroaliphatic, alicyclic or heteroalicyclic or aromatic or heteroaromatic group;
b) a polymer or oligomer comprising repeat units -[H1-AA]-, -[DV-AA]-, and -[D2-O-AA]-, where D2 is independently in each occurrence an aliphatic or heteroaliphatic, alicyclic or heteroalicyclic or aromatic or heteroaromatic group;
c) a polymer or oligomer comprising repeat units -[H1-AA]-, -[R—O-AA]-, and -M-(AA)ₙ-, wherein M is an n valent organic moiety, and n is 3 or more;
d) a polymer or oligomer comprising repeat units -[H1-AA]-, -[R—O-AA]-, and -PA-(CO—O—R)ₙ—, wherein PA is an n valent organic moiety, and n is 3 or more;
e) a polymer or oligomer comprising repeat units -[H2-D]-, and -[R—O-AA]-, where H2 is —CO—R—CO—NH—R—NH—CO—R—CO—O— where R is independently in each occurrence an aliphatic or heteroaliphatic, alicyclic or heteroalicyclic or aromatic or heteroaromatic group, and where D is -[R—O]-;
f) a polymer or oligomer comprising repeat units -[H2-D]-, -[R—O-AA]-, and -M-(AA)ₙ-, where H2 is —CO—R—CO—NH—R—NH—CO—R—CO—O— where R is independently in each occurrence an aliphatic or heteroaliphatic, alicyclic or heteroalicyclic or aromatic or heteroaromatic group, and where D is -[R—O]-;
g) a polymer or oligomer comprising repeat units -[H2-AA]-, -[R—O-AA]-, and -PA-(COOR)n-;
h) a polymer or oligomer having the formula HO-D1-O—[—CO-AA1,2-CO—O-D1-O-]x-[CO-AA1,2-CO—O-AD-O]y-H, wherein O-D1-O represents the residual of a diol functionality, wherein CO-AA1,2-CO represents the residual of an aliphatic dicarboxylic acid functionality or a high boiling point diacid ester functionality, wherein O-AD-O represents the residual of a polyamide diol functionality, wherein x and y are the number of repeat units within the polymer block inside the brackets;
i) a polymer or oligomer comprising repeat units -[H2-D]-, -[H2-O-D2]-, [D-AA]-, and -[D2-O-AA]-;
j) a polymer or oligomer having the formula HO-D1-O—[—CO-AA1,2-CO—O-D1-O-]x-[CO-AA1,2-CO—O—CO-DD-CO]y-OH, wherein O—CO-DD-CO—O represents the residual of a diamide diacid functionality; and
k) mixtures thereof.

12. A process according to claim 11, wherein the self-assembling material is selected from the group consisting of the polymer or oligomer of a), b), c), d), f), g), h), i), j) and mixtures thereof.

13-19. (canceled)

20. A process according to claim 11 wherein the polymer or oligomer comprises the formula:
—[C(O)R′C(O)O—R″O]ₓ—[C(O)R′C(O)O—RC(O)N(H)RaN(H)C(O)RO]_{y}—
wherein R is independently in each occurrence an aliphatic or heteroaliphatic, alicyclic or heteroalicyclic or aromatic or heteroaromatic group;
R′ is a bond or an aliphatic group;
R″ is an aliphatic or heteroaliphatic, alicyclic or heteroalicyclic or aromatic or heteroaromatic group;
Ra is a bond or is an aliphatic or heteroaliphatic, alicyclic or heteroalicyclic or aromatic or heteroaromatic group; and
the number average molecular weight of the polymer or oligomer is between about 1000 g/mol and about 30,000 g/mol.

21. A process according to claim 11 wherein the polymer or oligomer is of the formula: 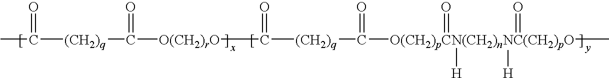
wherein
p, q, and r are independently 2, 3, 4, 5, 6 or 8;
n is 2-6 and
the number average molecular weight of the polymer or oligomer is between about 1000 g/mol and 30,000 g/mol.

22. A process according to claim 21 wherein n is 2.

23. A process according to claim 21 wherein the polymer or oligomer is of the formula:

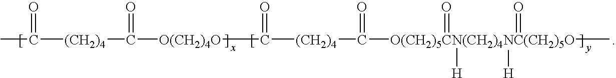

24-29. (canceled)

30. A process according to claim 20 wherein the number average molecular weight of the polymer or oligomer is between about 2000 g/mol and about 20,000 g/mol.

31. (canceled)

32. A process according to claim 1, wherein the fibers have an average diameter of about 1000 nanometers or less.

33. A process according to claim 1, wherein viscosity of the self assembling material is less than 100 pascal-seconds (Pa.sec.) at from above Tm up to about 40 degrees Celsius (° C.) above Tm.

34-39. (canceled)

40. A process according to claim 1, wherein the fibers have an average diameter of from about 30 nm to about 1000 nanometers and the fibers are produced at a rate, expressed in grams per minute (g/min), at least 2 times a solvent-normalized rate, expressed in g/min, of producing corresponding diameter fibers from the self assembling material with a solvent-based electrospinning process.

41. Fibers fabricated by the process according to claim 1.

42. Fibers fabricated according to the process of claim 1 having an average diameter of about 30 nm to about 1000 nm

43-46. (canceled)

47. A filtration non-woven comprising fibers as in claim 41.

48. A filtration non-woven as in claim 47, the filtration non-woven being for air or gas filtration.

49. (canceled)

50. (canceled)

51. A process as in claim 1, wherein the oligomers or polymers have a statistical distribution of the repeat units.
